(19) United States
(12) Patent Application Publication
(10) Pub. No.: US 2016/0230863 A1
(43) Pub. Date: Aug. 11, 2016

(54) SPLIT POWER PATH TRANSMISSION WITH MULTI-SPEED COMBINER

(71) Applicant: KINETICS DRIVE SOLUTIONS INC., Langley (CA)

(72) Inventors: Gerald Dyck, Abbotsford (CA); John Czepak, Langley (CA)

(21) Appl. No.: 15/022,538

(22) PCT Filed: Sep. 8, 2014
(86) PCT No.: PCT/CA2014/050846

§ 371 Date: Mar. 16, 2016

Related U.S. Application Data
(60) Provisional application No. 61/878,608, filed on Sep. 17, 2013.

(51) Int. Cl. F16H 37/08; F16H 47/02

(52) U.S. Cl. CPC F16H 37/084; F16H 37/0846; F16H 47/02

(57) ABSTRACT

An improved split power path transmission with a combiner is disclosed which comprises an input power splitter that splits input power between at least one fixed-ratio mechanical power path and at least one variable-ratio power path. The outputs of the fixed-ratio and variable-ratio power paths are combined by coupling their outputs to a combiner. The transmission also comprises a multi-speed drive assembly comprising at least two selectable gear ratios. The transmission can be made more compact by incorporating the multi-speed drive assembly between the input and output of the variable-ratio power path.

### TECHNICAL FIELD

The present invention pertains to split power path transmissions for use in vehicles.

### BACKGROUND

Split power path transmission architectures are used in numerous types of hybrid vehicle drives and as continuously variable powertrains. In a simple split power path transmission, power is split into two paths. The power splitter is usually a planetary type which allows for speed variations between the input and the outputs, but has a fixed torque split between the input element and the two output elements. One power path is typically a simple mechanical path with a fixed speed and torque ratio. The other power path contains a variator element which provides for variable speed and torque ratios. Power is recombined from the outputs of the two paths at a combiner gear.

In operation, when starting from zero speed, the transmission starts with non-zero speed and torque at its input and zero speed at its output. The variator is adjusted to provide up to maximum torque multiplication through the variator power path. As the transmission output begins to turn, the variator torque ratio decreases while the speed of the variator input starts to drop. When the variator input speed approaches zero, essentially the only power transferred through the variator (and hence the variator path) is due to volumetric losses (e.g. slippage). Instead, power is transferred almost exclusively through the fixed mechanical power path.

Numerous variator configurations are known in the art. And of these, hydraulic variator types are often preferred. For instance, the variator may comprise a hydrostatic pump and motor set. Generally in vehicular applications, it is desirable to minimize the space, weight, and cost of components. For this purpose in the case of such split power path transmissions, it is particularly desirable to minimize the size of the hydraulic portion of the transmission. Further, depending on the duty cycle required of the transmission, it is often not optimal to have a single variator handle all the required operating conditions. In such cases, a simple approach to increase the operating range of such a transmission is to add a multi-speed transmission (e.g. auxiliary gearbox) to the output of the split power path transmission. This approach allows a smaller variator to be used. However, it adds significant weight and axial length to the transmission.

As examples, the German company Fendt has developed continuously variable transmissions primarily for agricultural vehicles and machines (e.g. the VARIO® transmission). These continuously variable transmissions employ such split power path designs and the additional use of a two speed auxiliary gearbox. These transmissions however employ a synchronizer assembly for the high and low speed ranges, and this can pose difficulties with regards to changing ranges while moving.

Also, in U.S. Pat. No. 7,357,744, Kinetics Drive Solutions discloses a hydro-mechanical continuously variable transmission (HMCVT) that employ such split power path designs. The HMCVT uses a planetary gear system to provide a combination of hydraulic and mechanical power for a vehicle or stationary equipment. The invention further comprises various ancillary elements to improve the performance of the HMCVT.

Notwithstanding the progress made to date, there is a continuing need to reduce the size, weight, and cost of these useful transmissions. The present invention addresses these and other needs as described below.

### SUMMARY

A split power path transmission can be made more compact by incorporating an appropriate multi-speed drive assembly within a variable-ratio power path in the transmission, before the outputs from the variable-ratio power path and other power paths are combined at a combiner. An appropriate multi-speed drive assembly for this purpose has at least two selectable gear ratios.

Such a split power path transmission comprises a transmission input and output, an input power splitter, at least one fixed-ratio mechanical power path and at least one variable-ratio power path, a combiner, and a multi-speed drive assembly. The input power splitter comprises an input and at least first and second outputs. The transmission input is connected to the power splitter input, the first output of the power splitter is connected to an input of the fixed-ratio mechanical power path, and the second output of the power splitter is connected to an input of the variable-ratio power path. The combiner couples outputs of the fixed-ratio mechanical power path and of the variable-ratio power path to the transmission output. The multi-speed drive assembly comprises at least two selectable gear ratios and is incorporated between the input and output of the variable-ratio power path.

To provide variable-ratio power, the variable-ratio power path can comprise a variator in which a variator input is connected to the second output of the power splitter and a variator output is connected to the multi-speed drive assembly. Various types of variators may be considered for this purpose, including those in the group consisting of a toroidal friction drive, a pulley with variable sleeves, a variable cone drive, an electrical generator and motor set, a hydrodynamic device or a hydrostatic device. In one desirable embodiment, the variator is a hydrostatic device comprising a hydrostatic pump and motor set.

In addition, various types of multi-speed drive assemblies may be employed. For instance, a suitable multi-speed drive assembly comprises a high speed friction clutch and a low speed friction clutch coupled in parallel between the variator output and the output of the variable-ratio power path. In other embodiments, a dog clutch or a synchronizer may be employed.

In exemplary embodiments, the power splitter used can be a planetary gear set. Transfer gears may be employed at various points in the transmission. Further, gear couplings may appear throughout the transmission, for instance in the variable-ratio power path and/or in the multi-speed drive assembly.

For many vehicles, including those for heavy duty use, it is sufficient to use an improved transmission of the invention with two speeds in the variable-ratio power path, i.e. the multi-speed drive assembly is a two-speed drive assembly.

### BRIEF DESCRIPTION OF THE DRAWINGS

FIG. 1 shows a schematic of a simple split power path transmission of the prior art.

FIG. 2 shows a schematic of a prior art split power path transmission with a two-speed auxiliary gearbox.

FIG. 3 shows a schematic of a split power path transmission of the invention with a two-speed drive assembly in the variable-ratio power path.

FIG. 4 shows a schematic of a split power path transmission of the invention with a two-speed drive assembly in the variable-ratio power path with alternative connections to the splitter.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

The “torque ratio of the transmission” is defined as the torque at the transmission output divided by the torque at the transmission input. The “speed ratio of the transmission” is defined as the speed at the transmission output divided by the speed at the transmission input.

“Variator” refers to a device which can vary the torque and speed ratios of a provided input. The torque ratio of the variator is defined as the torque at the variator output divided by the torque at the variator input. The speed ratio of the variator is defined as the speed at the variator output divided by the speed at the variator input.

Herein, the combination of a multi-speed drive assembly and a combiner is known as a multi-speed combiner.

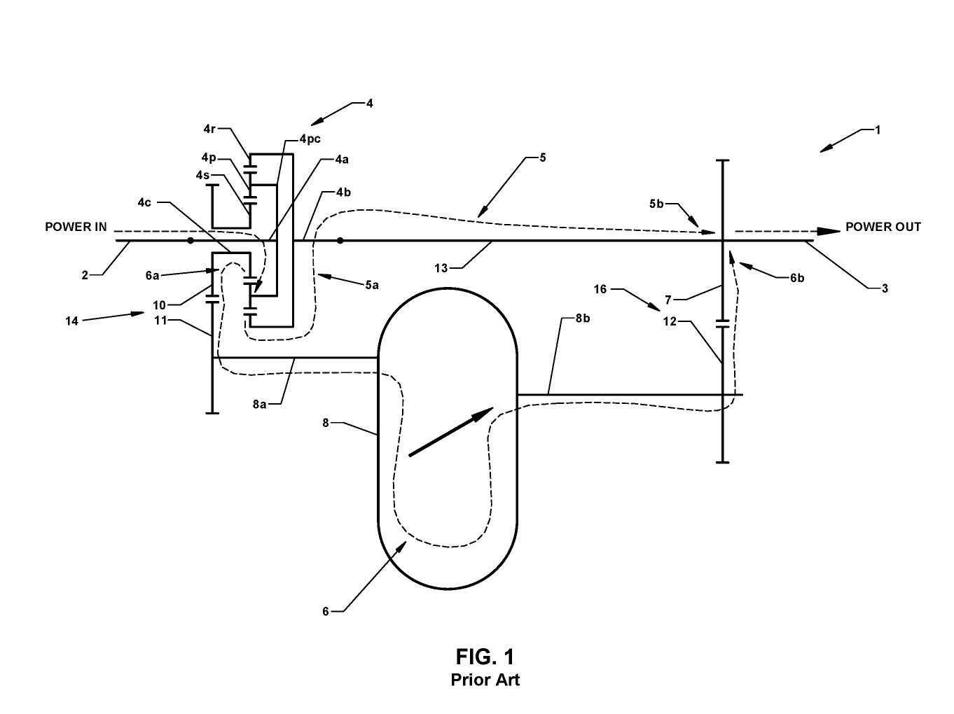

A schematic of a simple, prior art split power path transmission having two power paths is shown in FIG. 1. Split power path transmission 1 comprises transmission input shaft 2 and transmission output shaft 3, input power splitter 4, fixed-ratio mechanical power path 5 (illustrated by dashed line), variable-ratio power path 6 (illustrated by dashed line), and combiner 16. Here, input power splitter 4 is a planetary gear set (as shown schematically) and the combiner 16 is a gear coupling consisting of combiner gear 7 and transfer gear 12. Variator 8 is employed to vary torque in variable-ratio power path 6, and comprises variator input 8a and variator output 8b. Also illustrated schematically in FIG. 1 is a gear coupling 14 consisting of transfer gears 10, 11, which are typically employed in actual embodiments, but whose number and location vary according to the specific design and configuration of the actual embodiment.

Transmission input shaft 2 is connected to input 4a of input power splitter 4. First output 4b and second output 4c of input power splitter 4 are connected to input 5a and input 6a of fixed-ratio mechanical power path 5 and variable-ratio power path 6 respectively. Output 5b and output 6b of fixed-ratio mechanical power path 5 and variable-ratio power path 6 respectively are connected with combiner gear 7 and shaft 13 where they are combined and coupled to transmission output shaft 3.

Input power to transmission 1 is thus split into two paths 5, 6. Input power splitter 4 allows for speed variations between input 4a and outputs 4b, 4c, but has a fixed torque split therebetween. Fixed-ratio mechanical power path 5 is a simple mechanical path with a fixed speed and torque ratio. Variable-ratio power path 6 provides for variable speed and torque ratios via variator 8. The power from each path is recombined at combiner gear 7 and shaft 13 and then transmission output shaft 3 from transmission 1.
In FIG. 1, input power splitter 4 is shown as a simple planetary gearset. Input 4a of input power splitter 4 is connected to planet carrier 4pc. First output 4b and second output 4c of input power splitter 4 are connected to planetary ring gear 4r and planetary sun gear 4s respectively

Variator 8 may be of numerous designs and configurations including a toroidal friction drive, a pulley with variable sheaves, a variable cone drive, an electrical generator/motor set, a hydrodynamic device or a hydrostatic device. In an exemplary embodiment, variator 8 is in the form of a hydrostatic pump and motor set.

At the start of operation, power is provided to transmission input shaft 2 at non-zero torque and speed, while transmission output shaft 3 is at zero torque and speed. Variator 8 is adjusted to provide up to a maximum torque multiplication through variable-ratio power path 6. At this time, no power is transferred through fixed-ratio mechanical power path 5, and all the power is transferred through variable-ratio power path 6. As transmission output shaft 3 begins to turn, the variator torque ratio of variator 8 decreases while the speed of the variator input 8a starts to drop. As the transmission approaches its highest speed ratio, the torque at variator output 8b approaches zero. Although there is a holding torque against power splitter output 4c, provided by variator 8, when the speed of variator input 8a approaches zero, the only power being transferred through variator 8 is due to volumetric losses (slippage, leakage, etc.) created by the variator design. At this time, because power is transferred between transmission input shaft 2 to output shaft 3 almost exclusively through the simple mechanical fixed-ratio mechanical power path 5, any mechanical efficiency losses through variator 8 do not have a significant effect.

Hydraulic variators are preferred devices for use in split power path transmissions like that of FIG. 1. And while such transmissions work effectively, in most mobile applications, it is desirable to minimize the hydraulic portions of the transmission in order to realize space, weight and cost savings. Depending on the duty cycle of the transmission, it may not be possible to have one variator optimized for all desired operating conditions. As mentioned above, an auxiliary multi-speed gearbox may thus be added to the output of the split power path transmission in order to increase the operating range of the transmission. With this approach, a smaller variator may be used. However, adding an auxiliary gearbox generally adds weight and significantly increases the axial length of the transmission.

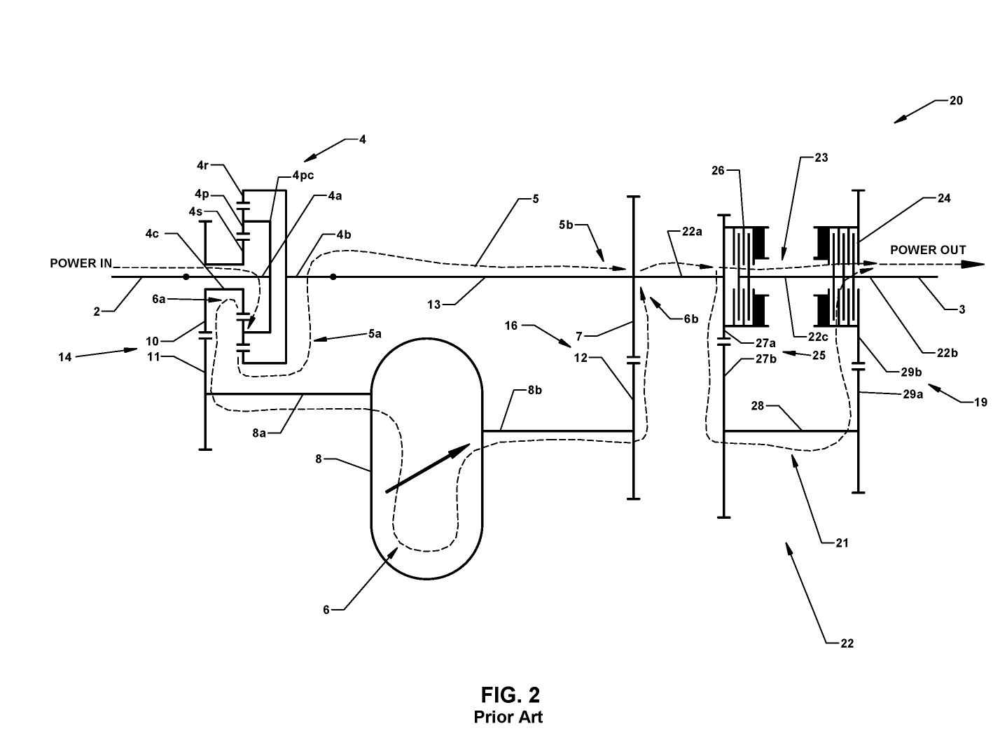

FIG. 2 shows a schematic of such a prior art split power path transmission with a two-speed auxiliary gearbox. (In FIG. 2, the same numerals have been used to indicate components in common to those in FIG. 1.) Split power path transmission 20 is similar to transmission 1 except that smaller variator 18 with input 18a and output 18b can be used in variable-ratio power path 6, and multi-speed drive assembly 22 is incorporated between combiner 16 and transmission output shaft 3.

In the embodiment of FIG. 2, multi-speed drive assembly 22 is a two-speed auxiliary gearbox with two selectable gear ratios. Drive power is provided from combiner gear 7 and shaft 13 to input 22a of multi-speed drive assembly 22 and is selectively directed through either low speed power path 21 or high speed power path 23 via appropriate engagement of low speed friction clutch 24 and high speed friction clutch 26. As shown, high speed power path 23 (illustrated by dashed line) comprises high speed friction clutch 26 and shaft 22c and power is directly routed from input 22a to output 22b of multi-speed drive assembly 22 here. Low speed power path 21 comprises gear couplings 19, 25, shaft 28 and low speed friction clutch 24, and power is more indirectly routed from input 22a to output 22b. Gear couplings 19, 25 consist of transfer gears 29a, 29b, and 27a, 27b respectively. To select low speed operation, low speed friction clutch 24 is engaged and high speed friction clutch 26 is disengaged. For high speed operation, low speed friction clutch 24 is disengaged and high speed friction clutch 26 is engaged.

As is evident from the arrangement shown in FIG. 2, incorporating multi-speed drive assembly 22 extends the operating range of the transmission and allows for use of smaller variator 18. However, it also significantly increases the axial length of split power path transmission 20. As well, the clutches must transfer the combined torque from all the fixed-ratio and variable-ratio power paths. The transmission of the invention on the other hand provides related benefits without requiring a significant increase in the length of the transmission as well as allowing for the use of smaller clutches.

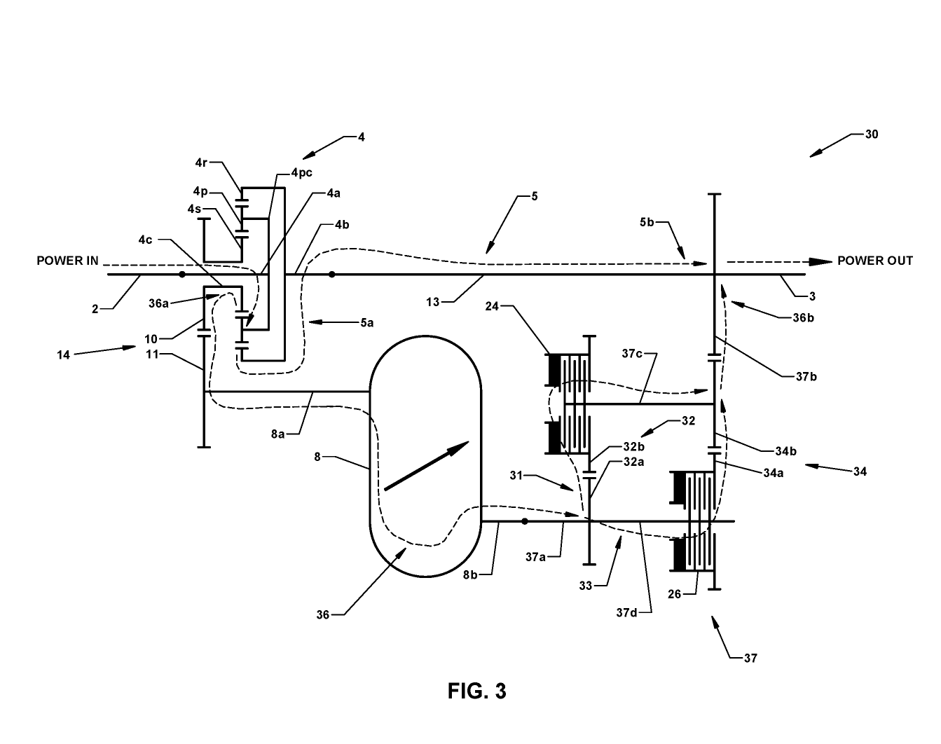

FIG. 3 shows a schematic of an exemplary split power path transmission of the invention with a two-speed drive assembly in the variable-ratio power path. (In FIG. 3, the same numerals have been used to indicate components in common to those in FIGS. 1 and 2.) Split power path transmission 30 in FIG. 3 is similar in many ways to transmission 20 in FIG. 2 except that multi-speed drive assembly 37 is located within variable-ratio power path 36 (illustrated by dashed line). As before, input 36a of variable-ratio power path 36 is connected to second output 4c of input power splitter 4. Output 5b and output 36b of fixed-ratio mechanical power path 5 and variable-ratio power path 36 respectively are connected with combiner gear 37b and shaft 13 respectively where they are combined and coupled to transmission output shaft 3. And within variable-ratio power path 36, input shaft 37a of multi-speed drive assembly 37 is connected to variator output 18b.

In the arrangement of multi-speed drive assembly 37, drive power is selectively directed through either low speed power path 31 or high speed power path 33 again via appropriate engagement of low speed friction clutch 24 and high speed friction clutch 26. As shown, low speed power path 31 comprises gear coupling 32, shaft 37c and low speed friction clutch 24. Gear coupling 32 comprises transfer gears 32a and 32b. High speed power path 33 comprises gear coupling 34, shaft 37d and high speed friction clutch 26. Gear coupling 34 comprises transfer gears 34a and 34b. Transfer gear 34b is drivingly engaged with combiner gear 37b and is also connected to shaft 37c. As before, low speed operation is selected by engaging low speed friction clutch 24 and disengaging high speed friction clutch 26, and vice versa for high speed operation. In other embodiments, other engagement devices such as synchronizers or dog clutches may be substituted for low speed friction clutch 24 and high speed friction clutch 26.

Use of multi-speed drive assembly 37 allows for more than one combiner ratio to be employed between variator 18 and transmission output shaft 3. In other embodiments, additional clutches, gear couplings and shafts may be employed to allow for three or more gear ratios between variator 18 and transmission output shaft 3.

Further, in the embodiment shown here, fixed-ratio mechanical power path 5 is shown schematically as simply consisting of shaft 13, but in alternative embodiments, additional transfer gears and shafts may be employed while maintaining a fixed ratio between input power splitter 4 and combiner 37b.

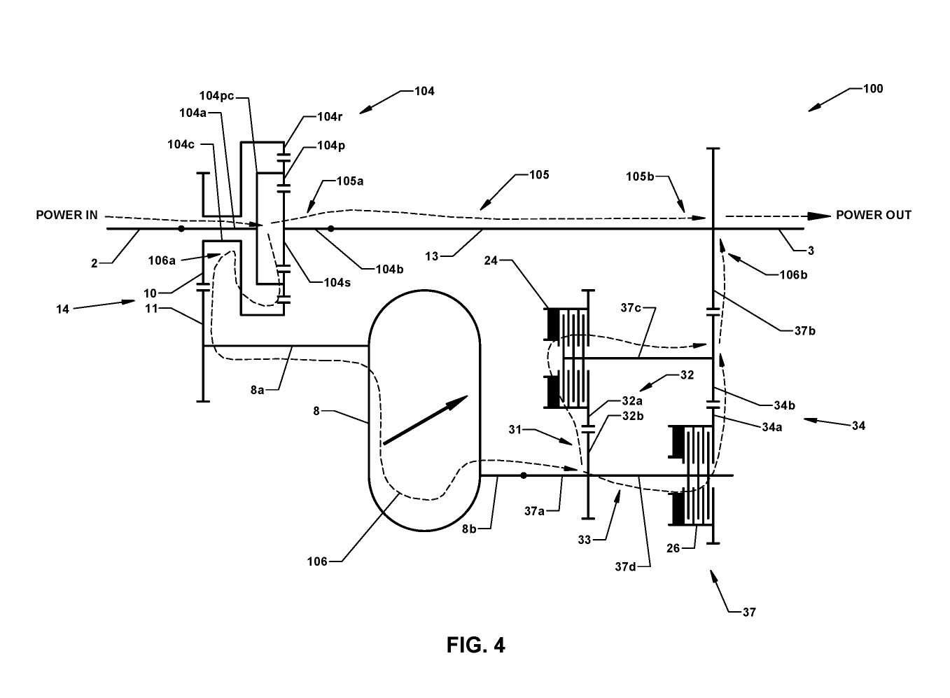

Also, in the embodiment shown here, input power splitter 4 is shown as a simple planetary gearset. The input 4a of input power splitter 4 is connected to planet carrier 4pc. First output 4b and second output 4c of input power splitter 4 are connected to planetary ring gear 4r and planetary sun gear 4s respectively. In other embodiments however, the input power splitter may be a connected in a different way. For example, FIG. 4 shows a schematic of a transmission similar to the one shown in FIG. 3 with the exception that power splitter 104 is connected differently than power splitter 4 of FIG. 3. In FIG. 4, input 104a of input power splitter 104 is connected to planet carrier 4pc. First output 104b and second output 104c of input power splitter 4 are connected to planetary sun gear 104s and planetary ring gear 104r respectively.

In further embodiments, different elements of a planetary gear set may be connected to the input and outputs of the input power splitter and the planetary could be of various types and configurations such as compound, Ravineaux, etc. (as known by those skilled in the art).

Packaging advantages can be realized with the arrangement in FIG. 3. By relocating the multi-speed functions off the transmission output shaft axis and onto the variator output axis, the length of overall transmission 30 can be reduced significantly. The gear train is effectively “folded up” on itself. But because variator 18 and the shaft in fixed-ratio mechanical power path 5 define the width of the transmission in actual embodiments, relocating multi-speed drive assembly 37 behind variator 18 in variable-ratio power path 36 does not increase the transmission width significantly.

A further advantage of the arrangement in FIG. 3 is that multi-speed drive assembly 37 does not need to be sized to handle the torque from both power paths and only needs to handle the torque in variable-ratio power path 36 from variator 18. A consideration however is that only the torque of variator 18 is multiplied and not the torque from mechanical power path 5.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A split power path transmission comprising:
a transmission input and a transmission output;
an input power splitter comprising an input and at least first and second outputs wherein the transmission input is connected to the power splitter input;
at least one fixed-ratio mechanical power path comprising an input and an output wherein the first output of the power splitter is connected to the input of the fixed-ratio mechanical power path;
at least one variable-ratio power path comprising an input and a output wherein the second output of the power splitter is connected to the input of the variable-ratio power path; and
a combiner coupling the outputs of the fixed-ratio mechanical power path and of the variable-ratio power path to the transmission output;
characterized in that the variable-ratio power path comprises a multi-speed drive assembly comprising at least two selectable gear ratios between the input and output of the variable-ratio power path.

2. The split power path transmission of claim 1 wherein the variable-ratio power path comprises a variator comprising an input and an output and wherein the variator input is connected to the second output of the power splitter and the variator output is connected to the multi-speed drive assembly.

3. The split power path transmission of claim 2 wherein the multi-speed drive assembly comprises a high speed friction clutch and a low speed friction clutch coupled in parallel between the variator output and the output of the variable-ratio power path.

4. The split power path transmission of claim 1 wherein the power splitter is a planetary gear set.

5. The split power path transmission of claim 1 wherein the multi-speed drive assembly is a two-speed drive assembly.

6. The split power path transmission of claim 2 wherein the variator is selected from the group consisting of a toroidal friction drive, a pulley with variable sleeves, a variable cone drive, an electrical generator and motor set, a hydrodynamic device or a hydrostatic device.

7. The split power path transmission of claim 6 wherein the variator is a hydrostatic device comprising a hydrostatic pump and motor set.

8. The split power path transmission of claim 2 wherein the variable-ratio power path comprises at least one gear coupling.

9. The split power path transmission of claim 3 wherein the multi-speed drive assembly comprises at least one gear coupling.

10. A method of transmitting power through a split power path transmission at multiple speeds, the split power path transmission comprising:
a transmission input and a transmission output;
an input power splitter comprising an input and at least first and second outputs wherein the transmission input is connected to the power splitter input;
at least one fixed-ratio mechanical power path comprising an input and an output wherein the first output of the power splitter is connected to the input of the fixed-ratio mechanical power path;
at least one variable-ratio power path comprising an input and a output wherein the second output of the power splitter is connected to the input of the variable-ratio power path; and
a combiner coupling the outputs of the fixed-ratio mechanical power path and of the variable-ratio power path to the transmission output;
and the method comprising:
incorporating a multi-speed drive assembly comprising at least two selectable gear ratios between the input and output of the variable-ratio power path.
